(19) United States
(12) Patent Application Publication
(10) Pub. No.: US 2022/0113273 A1
(43) Pub. Date: Apr. 14, 2022

(54) POTENTIOSTAT CURRENT-POTENTIAL DECOUPLER FOR USE IN ELECTROCHEMICAL EXPERIMENTS

(71) Applicant: The Regents of the University of California, Oakland, CA (US)

(72) Inventors: Peter Agbo, Oakland, CA (US); David Larson, Helena, MT (US)

(21) Appl. No.: 17/495,631

(22) Filed: Oct. 6, 2021

Related U.S. Application Data
(60) Provisional application No. 63/090,359, filed on Oct. 12, 2020.

(51) Int. Cl. G01N 27/30; G01N 27/327; G01N 27/417

(52) U.S. Cl. CPC G01N 27/305; G01N 27/417; G01N 27/3277

(57) ABSTRACT

This disclosure provides systems, methods, and apparatus related to electrochemistry. In one aspect, an apparatus includes a light source and a potentiostat. The potentiostat is operable to be connected to an electrochemical cell. A counter electrode connection of the potentiostat is operable to be connected to a photoelectrode of the electrochemical cell. A working electrode connection of the potentiostat is operable to be connected to the working electrode of the electrochemical cell. The light source positioned to illuminate the photoelectrode when the light source is operating. When the apparatus is in operation, the potentiostat is used to bias the photoelectrode to allow for control of the voltage applied to the electrochemical cell, and an intensity of light incident upon the photoelectrode is varied to allow for control of the current applied to the electrochemical cell.

### RELATED APPLICATIONS

This application claims priority to U.S. Provisional Patent Application No. 63/090,359, filed 12 Oct. 2020, which is herein incorporated by reference.

### STATEMENT OF GOVERNMENT SUPPORT

This invention was made with government support under Contract No. DE-AC02-05CH11231 and Contract No. DE-SC0004993, both awarded by the U.S. Department of Energy. The government has certain rights in this invention.

### TECHNICAL FIELD

This disclosure relates generally to electrochemistry and more particularly to the characterization of electrochemical devices.

### BACKGROUND

Generally, electrocatalyst studies are conducted under the implicit assumption that current and potential are not variables that may be independently controlled because they are inextricably linked, with an applied voltage ramp yielding a current response characteristic of the particular system under investigation. Consequently, an electrochemist treats the region of testable conditions as being limited to combinations of current density (J) and voltage (V) that fall along an electrocatalyst's polarization curve. This co-dependence of the current and voltage in typical electrochemical apparatus is limiting, as it effectively treats the energy of an electron and the rate it flows through an electrochemical system as coupled quantities. The general acceptance of this current state is surprising, when the electrochemist stops to consider the less-constrained characterization methods enjoyed by a photochemist; in luminescence measurements, photon fluxes are routinely controlled (e.g., by modulating the lamp intensity using slits or filters) independently from the energy of the photon being probed (e.g., through use of a monochromator).

### SUMMARY

Described herein are methods and apparatus for an experimentalist to independently control current and voltage in an electrochemical experiment, using a light source and a voltage source (e.g., such as a potentiostat). In standard electrochemical experiments, a potentiostat can be used to set either voltage or current; if current is set, only a unique voltage can be tested. Similarly, if voltage is set, only a unique current can be tested. The methods and apparatus described herein decouple current and voltage, allowing an experimentalist to independently vary one parameter (either current or voltage) without changing the other. This expands the range of conditions over which an electrochemical experiment can be run.

One innovative aspect of the subject matter described in this disclosure can be implemented in an apparatus including a light source and a potentiostat. The potentiostat is operable to be connected to an electrochemical cell. A counter electrode connection of the potentiostat is operable to be connected to a photoelectrode of the electrochemical cell. A working electrode connection of the potentiostat is operable to be connected to a working electrode of the electrochemical cell. The light source positioned to illuminate the photoelectrode when the light source is operating. When the apparatus is in operation, the potentiostat is used to bias the photoelectrode to allow for control of the voltage applied to the electrochemical cell, and an intensity of light incident upon the photoelectrode is varied to allow for control of the current applied to the electrochemical cell. In some implementations, when the apparatus is in operation, the photoelectrode and the working electrode are immersed in an electrolyte.

In some implementations, the photoelectrode is an anode, and the working electrode is a cathode. In some implementations, the photoelectrode is a cathode, and the working electrode is an anode. In some implementations, the apparatus is operable to independently control the current and the voltage when operating the electrochemical cell.

In some implementations, the intensity of light incident upon the photoelectrode is varied by varying the intensity of light emitted from the light source. In some implementations, the apparatus further comprises a variable neutral density filter positioned between the light source and the photoelectrode. The intensity of light incident upon the photoelectrode is varied using the variable neutral density filter.

In some implementations, the photoelectrode comprises a photoactive semiconductor.

In some implementations, the apparatus further comprises an iris positioned between the light source and the photoelectrode. In some implementations, the apparatus further comprises a convex focusing optic between the light source and the photoelectrode.

In some implementations, the light source comprises a monochromatic light source. In some implementations, the light source comprises a broad-spectrum light source. In some implementations, the light source comprises a xenon lamp.

Another innovative aspect of the subject matter described in this disclosure can be implemented in an apparatus including a light source and a potentiostat. The potentiostat is operable to be connected to an electrochemical cell. A working electrode connection of the potentiostat is operable to be connected to a photoelectrode of the electrochemical cell. A counter electrode connection of the potentiostat is operable to be connected to a counter electrode of the electrochemical cell. A reference electrode connection of the potentiostat is operable to be connected to a reference electrode of the electrochemical cell. The light source positioned to illuminate the photoelectrode when the light source is operating. When the apparatus is in operation, the potentiostat is used to bias the photoelectrode to allow for control of the voltage applied to the electrochemical cell, and an intensity of light incident upon the photoelectrode is varied to allow for control of the current applied to the electrochemical cell. In some implementations, the photoelectrode, the counter electrode, and the reference electrode are immersed in an electrolyte.

Another innovative aspect of the subject matter described in this disclosure can be implemented in a method including providing an apparatus and an electrochemical cell. The apparatus comprises a light source and a potentiostat. The apparatus is connected to the electrochemical cell. A counter electrode connection of the potentiostat is connected to a photoelectrode of the electrochemical cell. A working electrode connection of the potentiostat is connected to the working electrode of the electrochemical cell. The photoelectrode is illuminated with light from the light source. A voltage applied to the electrochemical cell is changed by biasing the photoelectrode with the potentiostat. A current applied to the electrochemical cell is changed by changing an intensity of light incident upon the photoelectrode.

In some implementations changing the current applied to the electrochemical cell does not change the voltage applied to the electrochemical cell. In some implementations the current applied to the electrochemical cell and the voltage applied to the electrochemical cell can be independently varied when characterizing the electrochemical cell.

In some implementations, the intensity of light incident upon the photoelectrode is varied by varying the intensity of light emitted from the light source. In some implementations the apparatus further comprises a variable neutral density filter positioned between the light source and the photoelectrode. The intensity of light incident upon the photoelectrode is varied using the variable neutral density filter.

In some implementations, the photoelectrode comprises a photoactive semiconductor. In some implementations, the light source comprises a monochromatic light source. In some implementations, the light source comprises a broad-spectrum light source. In some implementations, the light source comprises a xenon lamp.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration of an apparatus for decoupling current and voltage in an electrochemical experiment.

FIG. 2 shows an example of a schematic illustration of an apparatus for decoupling current and voltage in an electrochemical experiment.

FIG. 3 shows an example of a schematic illustration of an electrochemical cell.

FIG. 4 shows an example of a flow diagram illustrating a method of using the apparatus.

FIG. 5A shows the cathodic electrocatalyst polarization in a dark electrolyzer.

FIG. 5B shows the simulated J-V response for light-coupled, electrocatalyst polarization.

FIG. 5C shows that with a photo-driven electrocatalyst, any polarization coordinate [V,J] in the region on or under the maximum current (−10 mA) polarization curve may be tested. FIG. 5D shows contour mapping of a simulated system.

FIGS. 6A and 6B show experimental confirmation of light-coupled electrolyzer behavior.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

The ease with which photon fluxes and photon energies are independently tuned in photophysics should prompt us to reconsider whether we cannot do the same for electrons (and holes) in electrocatalysis. Examination of one-electron transfers in biological systems demonstrates that the decoupling of kinetics and energetics is indeed a physical possibility for electronic carriers. In proteins, an electrical potential is set by the difference in redox potential (Δε) between a donor (D) and acceptor (A) site between which an electron is transferred. Meanwhile, the kinetics of electron transport through proteins are governed by semi-classical Marcus Theory, where the electron tunneling rate (dq/dt) between a donor and acceptor is controlled by multiple factors, including the Δε between these sites and the distance (r) between them:

$$\begin{matrix}\frac{d q ( r , Δϵ )}{d t} = \frac{4 {π}^{2}}{h \sqrt[4]{πλ {k}_{B} T}} \vert {H}_{D A} \vert exp ( - \frac{{[ - nF Δ ϵ + λ ]}^{2}}{4 λ {k}_{B} T} ) ; & eq . ( 1 a ) \\ {H}_{D A} = {H}_{D A}^{0} exp ( - \frac{1}{2} β ( r - {r}_{0} ) ) . & eq . ( 1 b )\end{matrix}$$

These relations, whose validity have been verified by both electrochemical and transient-spectroscopic measurements of intramolecular electron transfer in model systems, underscore how only varying r for a given electronic potential Δε, enables the modulation of electron transfer rates, dq/dt, independent of electron energies (qΔε). Clearly, charge propagation in natural systems already provides demonstration of the broader, fundamental notion that independent control over the energy of a charge carrier, and its rate of extraction from or delivery to a substrate, is physically possible. What remains is finding a way of exploiting this fact in an experimentally viable manner that advances our basic understanding of, and control over, electrochemical reaction phenomena. It is critical to note that above-invocation of Marcus Theory, while relevant to the biological example provided above, is not central to the embodiments described herein.

Described herein is how such current-potential (J-V) decoupling can be achieved by exploiting the properties of a photoelectrode, which is shown to enable current-potential decoupling as a tool for interrogating electrochemical reactions. The ability to vary electron energy by biasing the photoelectrode with a potentiostat across a range of potentials, while independently limiting the total current (i.e., the rate of electron flow) by modulating the photoelectrode illumination intensity, is used to yield a J-V decoupled system. The embodiments described herein expand the region of testable electrochemical conditions from the conventional 1-D polarization response to a 2-D surface, defined by the integral of the light-coupled polarization curve under maximum illumination. This strategy marks a change of the traditional photoelectrochemical cell, where biasing the photoelectrochemical cell is now used as an electroanalytical tool for catalyst characterization, as opposed to a mere device for producing fuels at a fixed operating point.

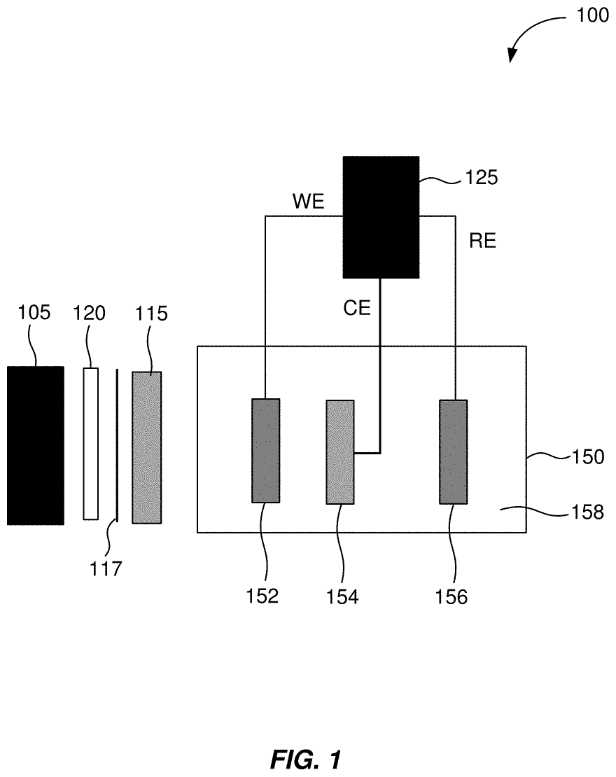

FIG. 1 shows an example of a schematic illustration of an apparatus for decoupling current and voltage in an electrochemical experiment. The apparatus includes a light source 105 and a potentiostat 125. The light source 105 is positioned to illuminate a photoelectrode 152 of an electrochemical cell 150 when the light source 105 is operating. The apparatus is connected to the electrochemical cell 150 that will be experimented upon or run using the apparatus.

In some embodiments, for a three-electrode cell configuration, a working electrode terminal of the potentiostat 125 is operable to be connected to the photoelectrode 152 of the electrochemical cell 150. A reference electrode terminal of the potentiostat 125 is operable to be connected to a reference electrode 156 of the electrochemical cell 150. A counter electrode terminal of the potentiostat 125 is operable to be connected to a counter electrode 154 of the electrochemical cell 150. The housing of the electrochemical cell 150 is transparent (e.g., transparent to light) in an area or areas such that the photoelectrode 152 can be illuminated with light. When in operation, light from the light source 105 is directed through housing of the electrochemical cell 150 and to illuminate the photoelectrode 152. In some embodiments, when the apparatus is in operation, the photoelectrode 152, the reference electrode 156, and the counter electrode 154 are immersed in an electrolyte 158.

When the apparatus is in operation, light from the light source 105 illuminates the photoelectrode 152. When illuminated, the photoelectrode 152 generates an electrical current that is used to drive an electrochemical reaction of interest in the electrochemical cell 150. The magnitude of the current produced by the photoelectrode 152 can be changed by altering an intensity of light incident upon the photoelectrode 152.

In some embodiments, the photoelectrode 152 comprises a photoactive semiconductor. In some embodiments, the light source 105 emits a wavelength or wavelengths of light to which the photoelectrode 152 is responsive. In some embodiments, the light source 105 comprises a monochromatic light source. In some embodiments, the light source 105 comprises a broad-spectrum light source. For example, in some embodiments, the light source 105 comprises a xenon lamp. In some embodiments, the xenon lamp has a power of about 150 Watts.

In some embodiments, the intensity of light incident upon the photoelectrode 152 is varied by varying the intensity of light emitted from the light source 105. In some embodiments, the apparatus further includes a variable neutral density filter 115 positioned between the light source 105 and the photoelectrode 152. A variable neutral is a filter that reduces or modifies the intensity of all wavelengths of light passing through the filter equally, and this modification of the intensity of all wavelengths of light can be varied. In some embodiments, the intensity of light incident upon the photoelectrode 152 is varied using the variable neutral density filter 115. In some embodiments, the variable neutral density filter 115 is a continuously-variable neutral density filter.

The potentiostat 125 can bias the photoelectrode 152, allowing for control of the voltage applied to the electrochemical cell 150. The magnitude of the current produced by the photoelectrode 152 can be changed by altering the intensity of light incident upon the photoelectrode 152. An increase or decrease in the intensity of the incident light (within a specified range) does not change the voltage produced by the photoelectrode 152. Thus, the light source intensity can be varied to change the electrical current in the electrochemical cell 150, without having to alter voltage. This allows the apparatus to independently control current and voltage when experimenting on or running using the electrochemical cell 150.

The independent control over current and voltage in an electrochemical experiment enabled by the apparatus described herein represents a significant difference from how typical electrochemical experiments are run using potentiostats. Normally, electrochemical current is a function of applied voltage, as described by the characteristic polarization response of an electrochemical system under investigation. As a result, when using a potentiostat, current and voltage in electrochemical experiments are coupled quantities that cannot be arbitrarily changed without changing the other. This is the prevailing assumption under most electrochemical experiments. The apparatus and methods described herein are a way in which control over current and voltage can be partitioned.

In some embodiments, further optical components, including an iris 117 and a convex focusing optic 120, are positioned between the lamp 105 and the photoelectrode 152. For example, the iris 117 and the convex focusing optic 120 may be used when light from the light source 105 is not collimated.

In some embodiments, instead of using a potentiostat 125, a power supply that generates a voltage output is implemented in the apparatus. In such an implementation, the power supply would apply a bias against the photoelectrode 152.

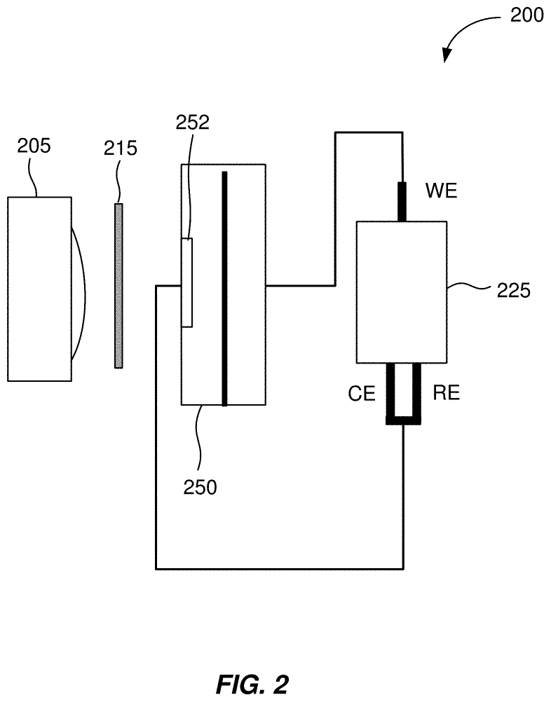

FIG. 2 shows an example of a schematic illustration of an apparatus for decoupling current and voltage in an electrochemical experiment. The apparatus shown in FIG. 2 is similar to the apparatus shown in FIG. 1.

As shown in FIG. 2, an apparatus 200 includes a light source 205 and a potentiostat 225. The apparatus 200 is operable to be connected to an electrochemical cell 250 that will be experimented upon or run using the apparatus. The light source 205 is positioned to illuminate a photoelectrode 252 of the electrochemical cell 250 when the light source 205 is operating. In some embodiments, the photoelectrode 252 comprises a photoactive semiconductor.

In some embodiments, for a two-electrode cell configuration, a counter electrode connection of the potentiostat 225 is operable to be connected to the photoelectrode 252 of the electrochemical cell. A working electrode connection of the potentiostat 225 is operable to be connected to the working electrode of the electrochemical cell. In some embodiments, when the apparatus is in operation, the photoelectrode 252 and the working electrode are immersed in an electrolyte.

When the apparatus is in operation, light from the light source 205 illuminates the photoelectrode 252. When illuminated, the photoelectrode 252 generates an electrical current that is used to drive an electrochemical reaction of interest in the electrochemical cell 250. The magnitude of the current produced by the photoelectrode 252 can be changed by altering an intensity of light incident upon the photoelectrode 252.

In some embodiments, the intensity of light incident upon the photoelectrode 252 is varied by varying the intensity of light emitted from the light source 205. In some embodiments, the apparatus further includes a variable neutral density filter 215 positioned between the light source 205 and the photoelectrode 252. A variable neutral is a filter that reduces or modifies the intensity of all wavelengths of light passing through the filter equally, and this modification of the intensity of all wavelengths of light can be varied. In some embodiments, the intensity of light incident upon the photoelectrode 252 is varied using the variable neutral density filter 215. In some embodiments, the intensity of light incident upon the photoelectrode 252 controls the maximum level of current that can be produced by the electrochemical cell 250. In some embodiments, the variable neutral density filter 215 is a continuously-variable neutral density filter.

Further, when illuminated, the photoelectrode 252 generates a voltage (or photovoltage). The current-voltage (polarization) characteristics of a photoelectrode 252 has a range of voltages where the current generated by the photoelectrode 252 remains constant.

The potentiostat 225 can bias the photoelectrode 252, allowing for control of the voltage applied to the electrochemical cell 250. The magnitude of the current produced by the photoelectrode 252 can be changed by altering the intensity of light incident upon the photoelectrode 252. An increase or decrease in the intensity of the incident light (within a specified range) does not change the voltage produced by the photoelectrode 252. Thus, the light source intensity can be varied to change the electrical current in the electrochemical cell 250, without having to alter voltage. This allows the apparatus to independently control current and voltage when experimenting on or running using the electrochemical cell 250.

In some embodiments, further optical components, including an iris (not shown) and a convex focusing optic (not shown), are positioned between the light source 205 and the counter electrode 252. For example, the iris and the convex focusing optic may be used when light from the light source 205 is not collimated.

In some embodiments, instead of using a potentiostat 225, a power supply that generates a voltage output is implemented in the apparatus. In such an implementation, the power supply would apply a bias against the photoelectrode 252.

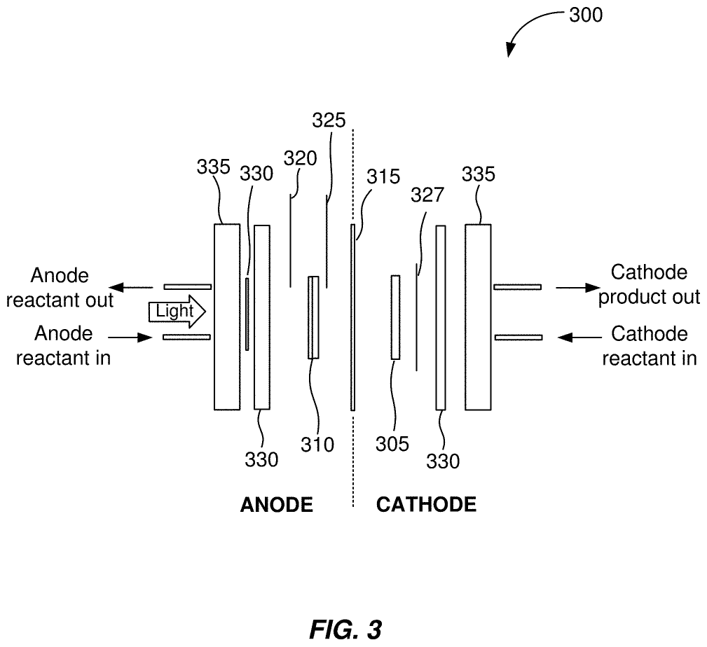

FIG. 3 shows and example of a schematic illustration of an electrochemical cell. As shown in FIG. 3, in the electrochemical cell 300, a photoelectrode is the electrochemical cell anode. In some embodiments, a photoelectrode is the electrochemical cell cathode.

The electrochemical cell 300 includes a cathode 305, an anode 310, and an ion exchange membrane 315. In some embodiments, the cathode 305 comprises an electrically-conductive substrate with cathode catalyst disposed thereon. In some embodiments, the anode 310 comprises a photoelectrode with a transparent catalyst layer disposed thereon.

In some embodiments, the electrochemical cell 300 includes a front contact anode current collector 320. In some embodiments, the electrochemical cell 300 includes a back contact anode current collector 325. The front contact anode current collector 320 and the back contact anode current collector 325 are both in electrical contact with the anode 310.

In some embodiments, the potentiostat of the apparatus is operable to be connected to the front contact anode current collector 320. The potentiostat being connected to the front contact anode current collector 320 allows voltage to be applied between the cathode and the electrolyte side of the anode 310. In this configuration, the applied voltage remains stable as current changes when measuring between the front contact anode current collector 320 and the cathode 305. This configuration may be desirable because the anode reactions take place at the front contact anode current collector 320, as it is exposed to electrolyte.

In some embodiments, the potentiostat of the apparatus is operable to be connected to the back contact anode current collector 325. The potentiostat being connected to the back contact anode current collector 325 allows the voltage to be applied between the cathode 305 and the dry side of the anode 310. In this configuration, the applied voltage remains stable as the current changes when measuring between the back contact anode current collector 325 and the cathode 305.

In some embodiments, the electrochemical cell 300 includes a cathode current collector 327. The cathode current collector 327 is in electrical contact with the cathode 305.

In some embodiments, the electrochemical cell includes gaskets 330. In some embodiments, the electrochemical cell 300 include endplates 335. In some embodiments, the endplates 335 are transparent to visible light.

In some other embodiments, the cathode comprises a photoelectrode with a transparent catalyst layer disposed thereon. In some embodiments, the anode comprises an electrically-conductive substrate with anode catalyst disposed thereon. In some embodiments, the cathode is in electrical contact with both a front contact cathode current collector and a back contact cathode current collector. In some embodiments, the anode is in electrical contact with an anode current collector.

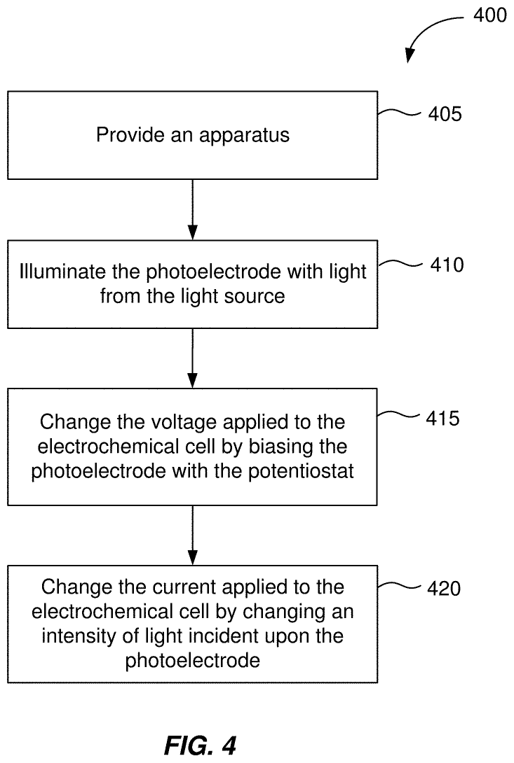

FIG. 4 shows an example of a flow diagram illustrating a method of using the apparatus. The method 400 shown in FIG. 4 may be implemented using the configuration of the apparatus shown in FIG. 2. A method of using the apparatus shown in FIG. 1 is similar to, and in some embodiments, the same as, the method of using the apparatus shown in FIG. 2.

Starting at block 405 of the method 400, an apparatus is provided. In some embodiments, the apparatus includes a light source and a potentiostat. The apparatus is connected to an electrochemical cell. A counter electrode connection of the potentiostat is connected to a photoelectrode of the electrochemical cell. A working electrode connection of the potentiostat is connected to the working electrode of the electrochemical cell.

At block 410, the photoelectrode is illuminated with light from the light source. This causes photoelectrode to generate a current (or photocurrent) and a voltage (or photovoltage).

At block 415, the voltage applied to the electrochemical cell is changed by biasing the photoelectrode with the potentiostat. The electrochemical cell still adheres to the traditional J-V relationship. Changing the voltage applied to the electrochemical cell will change the current per the J-V relationship. Then, however, the current applied to the electrochemical cell can be arbitrarily changed at block 420.

At block 420, the current applied to the electrochemical cell is changed by changing an intensity of light incident upon the photoelectrode. Changing the current applied to the electrochemical cell does not change the voltage applied to the electrochemical cell. Any of the curves of the J-V relationship of the electrochemical cell between a minimum intensity of light and a maximum intensity of light can be accessed.

In some embodiments, the intensity of light incident upon the photoelectrode is changed by changing the intensity of light emitted from the light source. In some embodiments, the apparatus further comprises a variable neutral density filter positioned between the light source and the photoelectrode. In such embodiments, the intensity of light incident upon the photoelectrode is changed using the variable neutral density filter. The optical density of the variable neutral density filter can be changed such that more light or less light is incident upon the photoelectrode.

In some embodiments, the current generated by the photoelectrode should not be higher than the current that the potentiostat can handle (e.g., about 650 mA for some potentiostats). In some embodiments, the voltage applied to the cell should not be higher than the breakdown voltage of an electrolyte used in the electrochemical cell.

Using the method 400, the current applied to the electrochemical cell and the voltage applied to the electrochemical cell can be independently varied when experimenting with or running the electrochemical cell.

In some embodiments, the photoelectrode comprises a photoactive semiconductor. In some embodiments, the light source comprises a monochromatic light source. In some embodiments, the light source comprises a broad-spectrum light source.

Using the apparatus and methods described herein allows for the expansion of the current-voltage coordinates that can be imposed on an electrochemical system under investigation or in operation. Typically, the only combinations of current and voltage that can be imposed on an electrochemical system are those current-voltage coordinates that lie on its characteristic polarization response curve. However, the methods described herein show that any coordinate falling within the region defined by the integral of the polarization response curve with respect to voltage, taken over arbitrary integration bounds V₀ to V₁ (where V₀ is the low voltage limit and V₁ is the high voltage limit), may now be tested. This expands the allowed set of electrochemical conditions that an experimentalist may test from just a 1-D curve (as given by the typical methods of polarization) to a 2-D region in the current-potential plane.

Since an experimentalist may independently control current and voltage when characterizing an electrochemical system, experiments using the apparatus and methods described herein can take a significant amount of time to run. Some potentiostats (e.g., industrial potentiostats) come with control software or a control system that enable automated voltage ramping. Such potentiostats can be used to characterize an electrochemical cell at a number of different voltages. A control system to allow automated control over current of the electrochemical cell by modulating light intensity incident upon the photoelectrode may include a microcontroller assembly or a motor to change the intensity of light emitted from the light source or the optical density of the neutral density filter, which changes the current generated by the photoelectrode. Using the combination of control systems for the potentiostat and the light intensity, an electrochemical cell can be characterized at a number of different voltage and a number of different currents; i.e., a specified voltage at a number of different currents of a specified current at a number of different voltages can be used to characterize the electrochemical cell.

An electrochemical cell can be characterized for different operating voltages and currents using the methods and apparatus described herein. If an electrochemical cell, for example, produces chemicals during operation, a voltage and current can be found using the apparatus and methods described herein that maximizes the production of one chemical while minimizing the production of other chemicals. The apparatus and methods described herein could also be used when running an electrochemical cell at a specific voltage and a specific current.

In an industrial setting (e.g., producing a chemical with an electrochemical device), the apparatus and methods described herein can be used to adjust the voltage and current of the electrochemical device to maximize production of the chemical when there is drift in the operating parameters of the electrochemical device. For example, in an experimental setting, a voltage and current can be found using the apparatus and methods described herein that maximizes the production of one chemical while minimizing the production of other chemicals, as described above. Then, in an industrial setting, an apparatus and electrochemical cell could be setup with a feedback loop that would keep the system stable and operating under conditions to maximize production of the chemical by changing the voltage and current from the set points that were found in the experiments.

### Examples

The following examples are intended to be examples of the embodiments disclosed herein, and are not intended to be limiting.

### Example

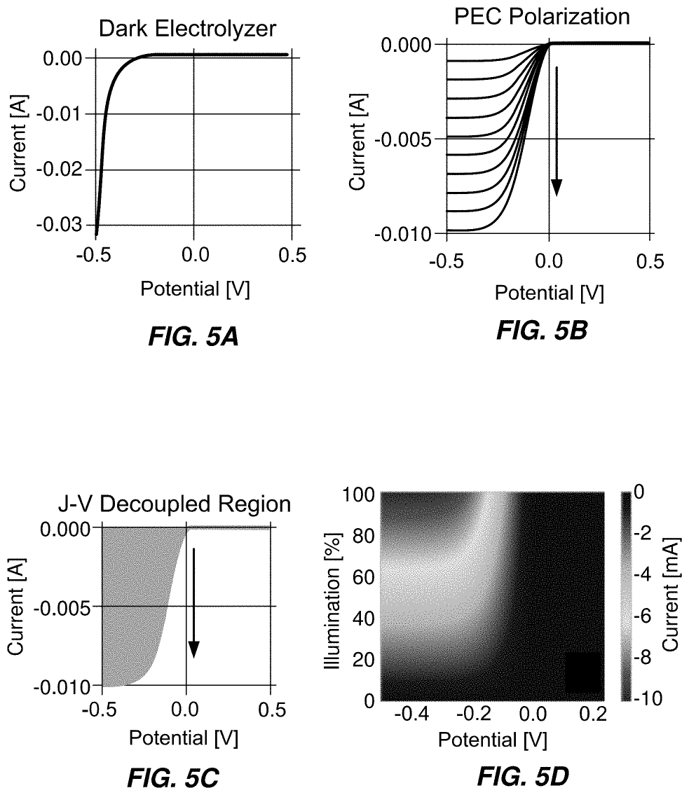

FIG. 5A shows the cathodic electrocatalyst polarization in a dark electrolyzer. In dark electrochemistry the only testable [V,J] coordinates lie on the catalyst dark polarization curve, preventing independent modulation of reaction kinetics (current) and thermodynamics (cell potential).

FIG. 5B shows the simulated J-V response for light-coupled, electrocatalyst polarization. The addition of a photovoltage causes a positive shift in the onset potential for electrocatalysis. Here, independent control over electrocatalyst applied voltage and current is achieved by biasing the photo-electrochemical device (voltage control) while separately varying the intensity of light incident on the photoelectrode (current control). At high cathode overpotentials, rates of electrocatalysis will be limited by the saturation current of the photoabsorber (about −10 mA). The arrow denotes increasing light illumination.

FIG. 5C shows that with a photo-driven electrocatalyst, any polarization coordinate [V,J] in the region on or under the maximum current (about −10 mA) polarization curve may be tested. The result is a system where current and voltage are effectively decoupled, with the set of accessible [V,J] coordinates now defined by the polarization curve integral at maximum illumination (shaded cyan region). The arrow denotes increasing light illumination.

FIG. 5D shows contour mapping of a simulated system, illustrating how a current can vary independent of voltage in the system, enabling independent control of electrochemical reaction kinetics and thermodynamics, and potentially greater control over electrolyzer product distributions.

### Example

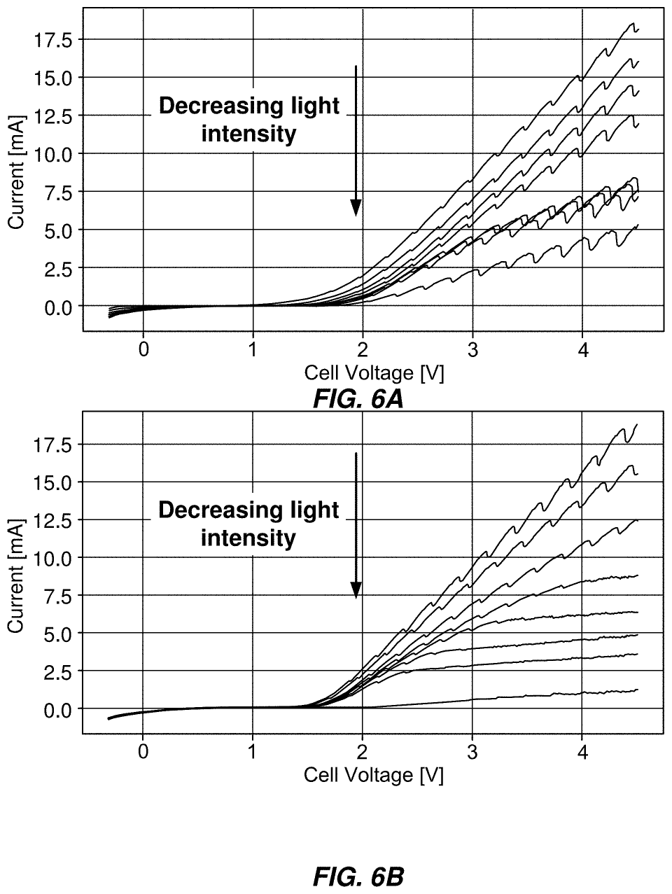

FIGS. 6A and 6B show experimental confirmation of light-coupled electrolyzer behavior. Decreasing light intensity decreases current flow through the cell at arbitrary values of applied voltages. This allows any current-voltage coordinate falling within the integral of the maximum illumination curve to be tested in electrocatalysis. FIG. 6A shows an example in which voltage is applied between the cathode (working electrode) and the photoanode's (counter electrode) solution-exposed front contact/catalyst layer. FIG. 6B shows an experiment in which voltage is applied between the cathode and the photoanode's dry back contact.

### Example—Discussion of Co-Optimization of Device Power and Photo-Electrochemical Product Distributions Through Cathode Dimensioning

While the application of J-V decoupling in electrochemistry should serve as an additional variable for tuning catalyst selectivity, in many cases, generating the desired product may require poising the system at current-potential coordinates where current falls far below the short-circuit current (I_{sc}) available at a given illumination level. In such cases, where the J-V coordinates for desired product selectivity and optimal power output do not overlap, J-V decoupling should signal precisely how to optimize photo-electrochemical device electrodes for both a target product/product distribution and power output. For a preferred selectivity found at some coordinate [V, J_{sc}/n], these results suggest that yielding the desired catalytic selectivity, without having to operate at the lower current, I_{sc}/n, requires increasing the cathode area by a factor of n (assuming, as is usually the case in photo-electrochemical systems, a cathode-limited device current). As a result, current density will be reduced to J_{sc}/n, with overall current still equal to I_{sc}. Since the system, even at short-circuit, is PV-limited, the increased cathode dimensions should not result in an overall increase in the device current in the light-coupled system. This yields an operating point where power and current are maximal (though current density is lower), with the system functioning at the desired polarization coordinate [V, J_{sc}/n].

### Example—Discussion of Relation to Molecular Electronics

In addition to the many demonstrations of voltage-independent, electron transfer rate modulation in proteins, the well-established field of molecular electronics has also (at least implicitly) focused on this very problem. In particular, the significant body of literature examining electron tunneling rates through alkyl self-assembling monolayers (SAMs) and aromatic spacer molecules as a function of chain length, provides unambiguous examples of J-V decoupling explored in electrochemical and photochemical systems. Electron tunneling currents in these studies were varied (for a given voltage) through systematic changes in donor-acceptor distance by varying lengths of organic spacer molecules, which provided insulating tunneling barriers between donor and acceptor sites. As with the biological systems described earlier, tunneling current density as a function of spacer length, at a constant voltage, scaled according to equations 1a and 1b. However, the natural extension of these sacrificial, donor-acceptor studies from the field of molecular electronics, into mainstream investigations over the improved degree of control that current-voltage decoupling could exert over electrocatalysis, was not made.

Finally, a clear implication arises from the disparate nature of Marcus theory's distance-dependence and the light-dependent approach taken by this study: the application of light marks just one particular route towards the general task of decoupling carrier kinetics and energetics. There is the possibility that additional routes to J-V decoupling may be conceived in a number of ways not yet realized.

### CONCLUSION

The ability to treat current and voltage as independent variables for the respective tuning of electrocatalyst reaction kinetics and thermodynamics, carries significant implications for the ability to influence electrochemical reaction pathways at the molecular level. This approach, which uses light as a tool for exacting greater control over electrocatalysis, runs contrary to the typical view through which photo-driven systems are generally considered—namely as devices for solar fuels generation operating at a unique power point, rather than electroanalytical tools for enabling increased control over catalyst polarization conditions and product, distributions.

Furthermore, the methods described herein here suggest how photo-driven device optimizations may be realized through appropriate cathode dimensioning. These benefits underscore the potential significance of establishing J-V decoupling as both a theoretical framework and an analytical probe for advancing mechanistic and device-level research in the field of (photo)electrochemistry.

It is worth noting that the expanded set of testable J-V coordinates offered by decoupling may suggest the value in re-examining some previously developed catalysts which have shown unexpectedly poor performances under the limitations of dark voltammetry. Finally, it, is anticipated that i-V decoupling may be especially useful for exploring materials with wider product distributions such as Cu CO₂ reduction catalysts, helping direct catalyst specificity towards C₂ and higher products.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. An apparatus comprising:
a light source; and
a potentiostat, wherein the potentiostat is operable to be connected to an electrochemical cell, a counter electrode connection of the potentiostat operable to be connected to a photoelectrode of the electrochemical cell, and a working electrode connection of the potentiostat operable to be connected to the working electrode of the electrochemical cell,
wherein the light source positioned to illuminate the photoelectrode when the light source is operating, and
wherein when the apparatus is in operation, the potentiostat is used to bias the photoelectrode to allow for control of the voltage applied to the electrochemical cell, and an intensity of light incident upon the photoelectrode is varied to allow for control of the current applied to the electrochemical cell.

2. The apparatus of claim 1, wherein the photoelectrode is an anode, and wherein the working electrode is a cathode.

3. The apparatus of claim 1, wherein the photoelectrode is a cathode, and wherein the working electrode is an anode.

4. The apparatus of claim 1, wherein the apparatus is operable to independently control the current and the voltage when operating the electrochemical cell.

5. The apparatus of claim 1, wherein the intensity of light incident upon the photoelectrode is varied by varying the intensity of light emitted from the light source.

6. The apparatus of claim 1, further comprising:
a variable neutral density filter positioned between the light source and the photoelectrode, wherein the intensity of light incident upon the photoelectrode is varied using the variable neutral density filter.

7. The apparatus of claim 1, wherein the photoelectrode comprises a photoactive semiconductor.

8. The apparatus of claim 1, further comprising:
an iris positioned between the light source and the photoelectrode.

9. The apparatus of claim 1, further comprising:
a convex focusing optic between the light source and the photoelectrode.

10. The apparatus of claim 1, wherein the light source comprises a monochromatic light source.

11. The apparatus of claim 1, wherein the light source comprises a broad-spectrum light source.

12. The apparatus of claim 1, wherein the light source comprises a xenon lamp.

13. An apparatus comprising:
a light source; and
a potentiostat, wherein the potentiostat is operable to be connected to an electrochemical cell, a working electrode connection of the potentiostat operable to be connected to a photoelectrode of the electrochemical cell, a counter electrode connection of the potentiostat operable to be connected to a counter electrode of the electrochemical cell, and a reference electrode connection of the potentiostat operable to be connected to a reference electrode of the electrochemical cell,
wherein the light source positioned to illuminate the photoelectrode when the light source is operating, and
wherein when the apparatus is in operation, the potentiostat is used to bias the photoelectrode to allow for control of the voltage applied to the electrochemical cell, and an intensity of light incident upon the photoelectrode is varied to allow for control of the current applied to the electrochemical cell.

14. A method comprising:
providing an apparatus and an electrochemical cell, the apparatus comprising a light source and a potentiostat, the apparatus being connected to the electrochemical cell, a counter electrode connection of the potentiostat connected to a photoelectrode of the electrochemical cell, and a working electrode connection of the potentiostat connected to the working electrode of the electrochemical cell;
illuminating the photoelectrode with light from the light source;
changing a voltage applied to the electrochemical cell by biasing the photoelectrode with the potentiostat; and
changing a current applied to the electrochemical cell by changing an intensity of light incident upon the photoelectrode.

15. The method of claim 14, wherein changing the current applied to the electrochemical cell does not change the voltage applied to the electrochemical cell.

16. The method of claim 14, wherein the current applied to the electrochemical cell and the voltage applied to the electrochemical cell can be independently varied when characterizing the electrochemical cell.

17. The method of claim 14, wherein the intensity of light incident upon the photoelectrode is varied by varying the intensity of light emitted from the light source.

18. The method of claim 14, wherein the apparatus further comprises a variable neutral density filter positioned between the light source and the photoelectrode, and wherein the intensity of light incident upon the photoelectrode is varied using the variable neutral density filter.

19. The method of claim 14, wherein the photoelectrode comprises a photoactive semiconductor.

20. The method of claim 14, wherein the light source comprises a broad-spectrum light source.
